(19) United States
(12) Patent Application Publication
(10) Pub. No.: US 2006/0292514 A1
(43) Pub. Date: Dec. 28, 2006

(54) Rotary breaker

(75) Inventor: Jean-Luc Mean, Chaudfontaine (BE)

Correspondence Address: REINHART BOERNER VAN DEUREN P.C., 2215 PERRYGREEN WAY, ROCKFORD, IL, 61107, US

(73) Assignee: Magotteaux International S.A., Vaux-Sous-Chevremont (BE)

(21) Appl. No.: 11/409,785

(22) Filed: Apr. 24, 2006

(30) Foreign Application Priority Data
Apr. 27, 2005 (CA) 2,505,441

(51) Int. Cl. F27D 15/02

(52) U.S. Cl. 432/77

(57) ABSTRACT

The present invention relates to a rotary breaker comprising support grates lined with modular wear parts fitted onto the holes of said support grates so as to reconstruct a wear grate over said support grate.

### FIELD OF THE INVENTION

The present invention relates to rotary breakers used for the extraction of oil from bituminous sands, and more particularly to a rotary breaker with wear parts making up a wear grate over a support grate.

### STATE OF THE ART

Many oil arisings around the world and in particular in Canada are in the form of bituminous sands. The separation of oil and sand requires the use of large drums called rotary breakers.

Rotary breakers work on the principle of a washing machine and are supplied with lumps of bituminous sand coming directly from extraction. The sand causes major wear of the inner coatings of these drums and in particular of the grates that allow these sands to be broken down and sieved.

Rotary breakers usually have a collar of variable diameter and length (for example 16′ by 48′) which rotates around a horizontal axis. Such a drum is shown in FIG. 1. Ramps of hot water under pressure contributes to the separation of crude oil and sand. The inner surface of this cylinder is lined with grates having a surface area of a few square metres and whose apertures allow to evacuate the broken down sand and the oil/water mixture (FIG. 2). Metal elements, called lifters, are also present on the inner surface on the one hand in order to lift the lumps of sand and facilitate their disintegration and on the other hand in order to move the material to be processed in the drum. The lifters of the state of the art always create inaccessible zones in the first rows of holes in the grate, which reduces the overall sieving surface available.

The inner elements of these drums are subjected to major wear stresses as a result of the abrasion by the sand and rocks. This is mainly due to the grates, which are manufactured by cutting thick metal plates and then reassembled by welding with a coating based on tungsten carbides.

Maintenance of these grates is not only costly because of the manufacturing time and of the price of the materials used but also because of the loss in production resulting from the shutdown of the unit for the time required for maintenance. In the event of localised preferential wear, it is necessary to replace an entire grate.

### AIMS OF THE INVENTION

The present invention aims to provide a rotary breaker comprising protection elements that are easily interchangeable and replaceable, borne by support grates. These protection elements make up a wear grate or protection grate over said support grate, allowing to limit the time required for the maintenance of the machine.

Another aim of the present invention is to propose a rotary breaker with support grates protected by wear parts with an inner circular arrangement that is replaced by a polyhedral structure, generally by an octagonal structure, in order to increase the impacts between the lumps of bituminous sand and thereby to improve the effectiveness of their disintegration.

### SUMMARY OF THE INVENTION

The present invention discloses a rotary breaker comprising support grates with modular wear parts fitting onto the holes of said support grate in such a way as to form a wear grate over said support grate.

According to particular embodiments, the invention comprises one or several of the following features:
the support grates of the drum are arranged in a polyhedral way;
the support grates of the drum are arranged in an octagonal way;
the modular wear parts comprise a system of ribs that allow said modular wear parts to be successively fitted into the support grate so that the preceding part is maintained by the following part;
the last row of modular wear parts is attached by a wedge;
the orifices of the modular wear parts have a draft from top to bottom so as to contribute to the evacuation of the broken down material;
the modular wear parts have a rectangular passage hole with the largest dimension in the motion direction of the material to be broken down inside the drum;
some modular wear parts have a blind hole;
the modular wear parts have a dismantling groove;
the modular wear parts have protrusions or lugs on some outer surfaces for attaching them and preventing them from coming out of the support grate;
the modular wear parts have ceramic components;
the wear parts have composite components;
the support grates also have lifters with orifices intended to receive modular wear parts;
the support grates and the lifters are attached by torus head shape bolts;
the recesses for the bolts are oval to prevent premature wear.

### BRIEF DESCRIPTION OF THE FIGURES

FIG. 1 schematically shows the principle of a rotary breaker.

FIG. 2 shows a picture of the grates arranged circularly as in the state of the art. This arrangement favours the sliding of agglomerated lumps along the wall.

FIG. 3 shows the polyhedral arrangement of the perforated plates as in the invention. This arrangement favours impacts between the agglomerated lumps of sand.

FIG. 4a shows a three-dimensional view of a wear part as in the invention and FIG. 4b shows a profile view of this part.

FIGS. 5a and 5b are sketches of the support grates with wear parts as in the invention and their attachment means.

FIGS. 6a and 6b show the lifter as in the invention with apertures.

FIG. 7 shows the attachment by bolts with a hexagonal head.

FIG. 8 shows the bolt used in the rotary breaker as in the invention.

### DETAILED DESCRIPTION OF THE INVENTION

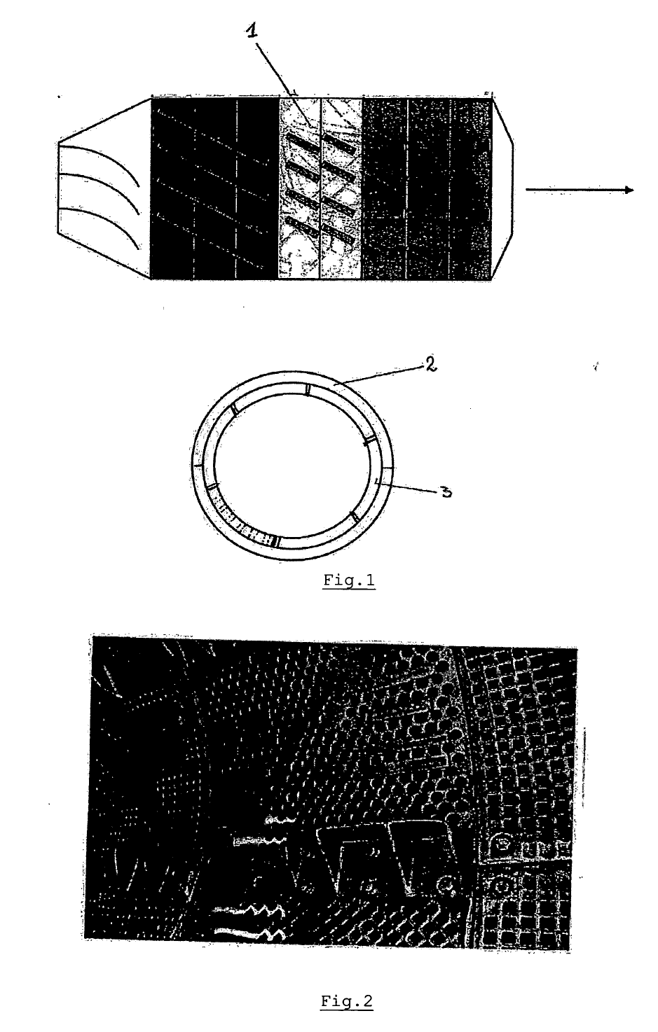

FIG. 1 schematically shows the principle of a rotary breaker 1 with an external frame made of beams, provided with perforated plates called grates that allow to break down and sieve the material to be processed.

In the design of the state of the art, the frame is of circular section and the perforated plates (grates) are bent to fit the inner shape of the structure. The rotation of the drum around its longitudinal axis causes the material processed to be blended and the injection of hot water under pressure, not shown in FIG. 1, favours the dilution and evacuation through the grates lining the structure.

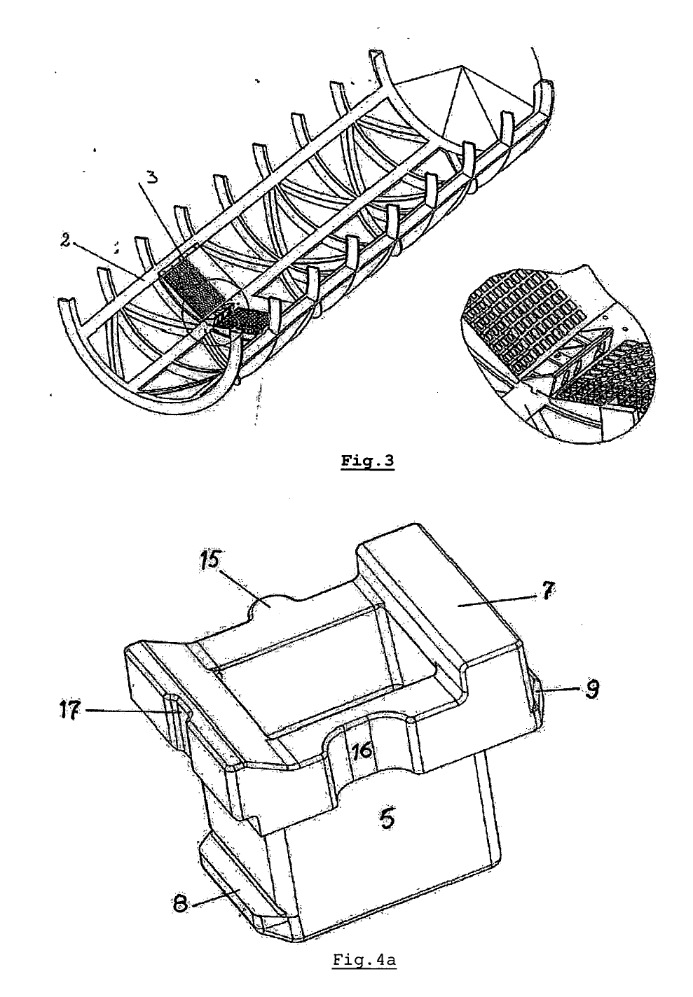

In the design of the invention (FIG. 3), support grates 3 are attached in such a way that they form a polyhedral casing 4 instead of a space with a circular cross-section. This inner polyhedral shape improves the effectiveness of the blending for the material by raising it further in the drum and by reducing the sliding over the grates, which reduces their wear.

In order to protect the grates and thereby to avoid replacing them too quickly, support grates 3 are used that are provided with wear parts 5 as shown in FIGS. 4a and 4b.

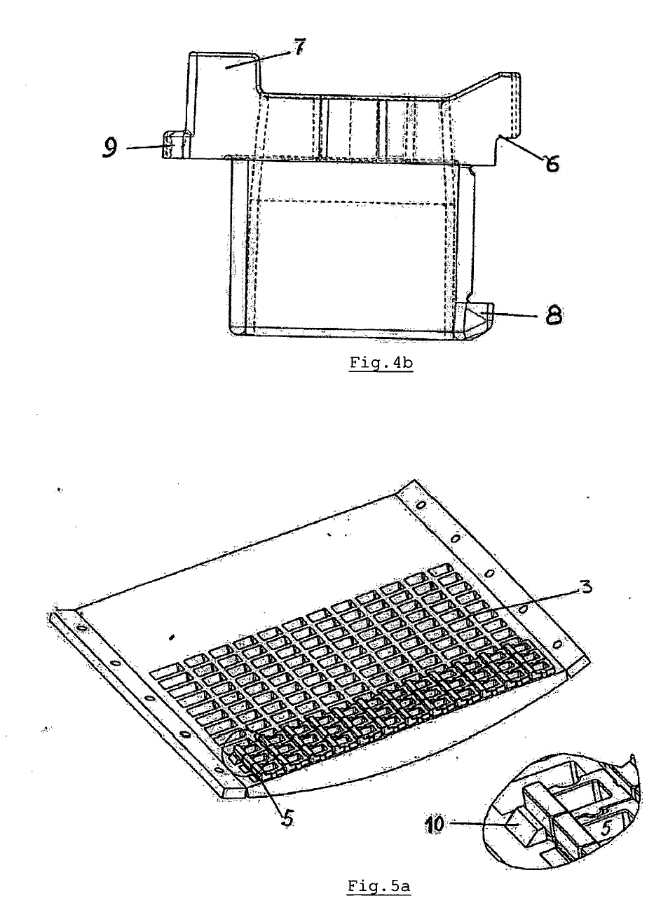

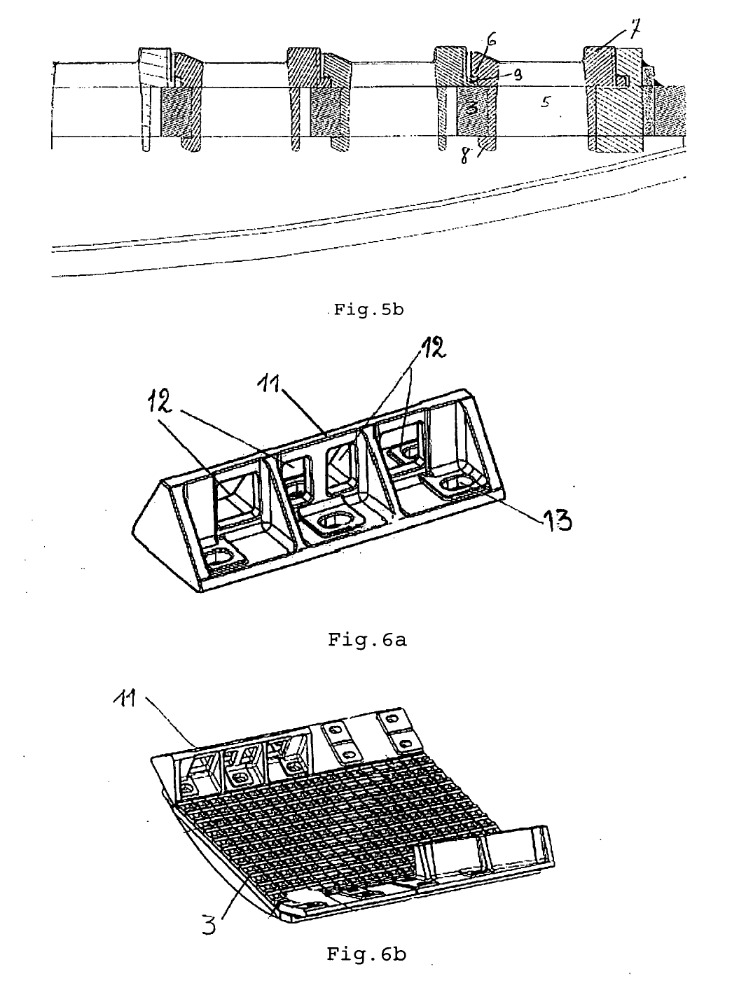

The wear parts 5 are designed so as to perfectly fit into the holes in the support grates 3. Their attachment to the support grate 3 is ensured by the rib 8 under the support grate 3 and the rib 9 on which the shoulder 6 of the following part rests, as shown in FIG. 5b. In this way, the parts are maintaining each other on the support grates 3 and only the last row is attached by means of a wedge 10 welded onto the support grate 3 (FIG. 5a). An entire wear grate is thus reconstructed over the support grate 3.

The wear parts also have a protrusion 7 whose role is to limit the sliding of the material and, taking into account the rotation direction of the drum, to force the material to pass through the orifice of the wear part.

FIGS. 5a and 5b show the way in which the wear parts 5 are assembled on the support grates 3, row by row.

The wear parts 5 also have a protrusion 15 and a groove 16 that serve to prevent the circulation of material between the wear parts 5 that would cause excessive wear of the grates.

Lastly, the groove 17 is intended to allow the insertion of a tool during dismantling.

Another aspect of the present invention is to increase the effectiveness of the blending caused by the lifters 11 located on the grates 3 parallel to the axis of the rotary breaker, by piercing them with orifices 12 that allow the processed material to pass through. These orifices allow the material to enter the first rows of holes in the grate 3, which is not the case if the lifter does not have these apertures 12. The working surface of the grate is thus increased. FIG. 6a shows an example of lifters 11 as in the invention and FIG. 6b shows their positions on the support grates 3.

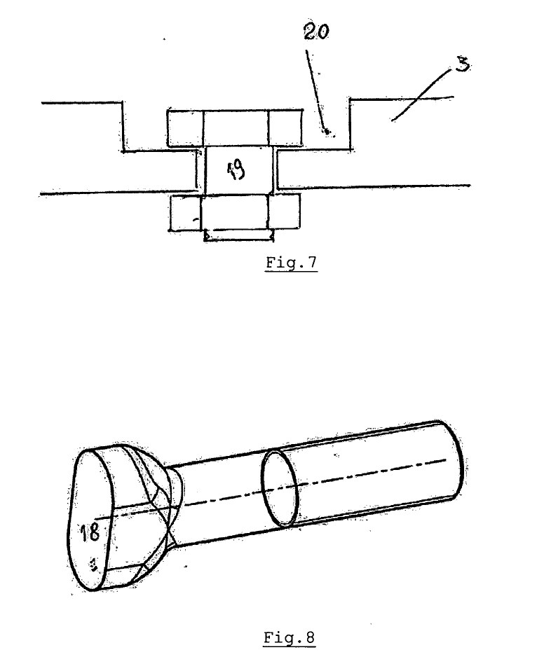

Another aspect of the present invention is the replacement of the bolts with hexagonal heads 19 for the attachment of the inner elements such as lifters 11, by special bolts with heads having a torus head shape support surface 18 that prevents the rotation of the bolt during tightening and as shown in FIG. 8. This type of bolt does not require a recess 20 (FIG. 7) for inserting a spanner, such a recess representing a weak point for wear resistance since it cannot be covered by a hard coating. Moreover, the head of the bolt is much thicker and there is thus more material to be worn before the head of the bolt is totally worn out.

In general, the positions of worn parts do not require the dismantling of unworn parts during their replacement. However, if maintenance of the drums 1 requires a relatively major dismantling of unworn parts, given the way they are fitted together, dismantling and reassembly are quick and easy operations.

According to the present invention, traditional grates are replaced by support grates whose holes are provided with wear parts in such a way as to reconstruct an entire wear grate over the support grate.

The wear parts 5 are of four types: left, right, with or without a passage (no passage=blind hole) and are made of metal or ceramic materials or from composite materials that are very resistant to wear (FIG. 4).

The wear parts 5 have passage holes that are preferably rectangular with the largest dimension in the motion direction of the material and a draft from top to bottom, in such a way as to contribute to the evacuation of the broken down material. In addition, at the end of the aperture, the protrusion 7 reduces the sliding of the material and the effort with which it enters the aperture. The wear parts also have protrusions or lugs on some outer surfaces so as to prevent the sliding of the sand between the parts, which would cause accelerated wear of the grates 3.

### KEY

1. Rotary breaker
2. Outer frame bearing the support grates
3. Support grates bearing the wear parts
4. Polyhedral casing
5. Modular wear part forming the base module for reconstructing an entire wear grate over the support grate
6. Shoulder on wear part
7. Protrusion on wear part to favour the passage of the material through the orifice in the wear part
8. Rib
9. Rib
10. Welded wedge attaching the last row of wear parts
11. Lifters
12. Lifter orifices
15. Protrusion
16. Fitting of wear parts
17. Dismantling groove
18. Torus head shape support surface
19. Bolts with hexagonal heads
20. Bolt recess

1. Rotary breaker comprising support grates (3) lined with modular wear parts (5) fitted onto the holes of said support grate (3) in such a way as to reconstruct a wear grate over said support grate (3).

2. Rotary breaker as in claim 1, wherein the support grates (3) are arranged in a polyhedral way.

3. Rotary breaker as in claim 1, wherein the support grates (3) are arranged in an octagonal way.

4. Rotary breaker as in claim 1, wherein the modular wear parts (5) comprise a system of ribs (8,9) allowing said modular wear parts (5) to be successively fitted into the support grate (3) so that the preceding part is maintained by the following part.

5. Rotary breaker as in claim 1, wherein the last row of modular wear parts (5) is maintained by a wedge (10).

6. Rotary breaker as in claim 1, wherein the orifices of the modular wear parts (5) have a draft from top to bottom so as to facilitate the evacuation of the broken down material.

7. Rotary breaker as in claim 1, wherein the modular wear parts (5) have a rectangular passage hole with the largest dimension in the motion direction of the material to be broken down inside the drum.

8. Rotary breaker as in claim 1, wherein some modular wear parts (5) have a blind hole.

9. Rotary breaker as in claim 1, wherein the modular wear parts (5) have a dismantling groove (17).

10. Rotary breaker as in claim 1, wherein the modular wear parts (5) have protrusions or lugs on some outer surfaces so as to attach them and to prevent them from coming out of the support grate (3).

11. Rotary breaker as in claim 1, wherein the modular wear parts (5) comprise ceramic components.

12. Rotary breaker as in claim 1, wherein the wear parts (5) comprise composite components.

13. Rotary breaker as in claim 1, wherein the support grates (3) also comprise lifters (11) provided with orifices intended to receive modular wear parts (5).

14. Rotary breaker as in claim 13, wherein the support grates (3) and the lifters (11) are attached by torus head shape bolts (18).

15. Rotary breaker as in claim 13, wherein the bolt recesses (20) are oval to prevent premature wear.
